(19) United States
(12) Patent Application Publication
(10) Pub. No.: US 2006/0218102 A1
(43) Pub. Date: Sep. 28, 2006

(54) Methods and apparatus for defining parameters for web based applications

(75) Inventors: William E. Gibson, Woodinville, WA (US); Azmat A. Pasha, Redmond, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/090,733

(22) Filed: Mar. 25, 2005

(51) Int. Cl. G06Q 99/00; H04L 9/00; H04K 1/00

(52) U.S. Cl. 705/80

(57) ABSTRACT

Methods and apparatus are provided for defining a contract for a web service. The contract may be defined, for example, in Web Service Definition Language (WSDL) or SOAP Service Description Language (SSDL) format. According to one embodiment of the invention, a software application is provided which implements one or more rules or assumptions to limit the functionality of a web service which the contract defines, such that a user interface provided by the application is less visually confusing to the user than conventional interfaces and the user may define the contract in a more intuitive manner.

### FIELD OF INVENTION

This invention relates to computer software, and specifically to software applications which may be used to develop other software applications.

### BACKGROUND OF INVENTION

Web services are web-based applications which are designed to interact with other applications, such as other web services or client applications. Web services may be deployed in private environments, such as within enterprises to enable divisions and/or subsidiaries to exchange data. Web services may also be deployed publicly. For example, a web service may be registered on the Internet via the Universal Description, Discovery and Integration (UDDI) initiative. Applications may search for a description of a service and, once an appropriate service is found, may interact with it, such as to complete a fee-based transaction.

A web service exposes its functionality via one or more endpoints, which are addressable ports through which an external application may exchange data with the web service. A particular endpoint may expose a plurality of functions or processes to an external application.

Communication with a web service is accomplished via messages. Specifically, in order to invoke a function provided by a web service, an external application typically transmits a “request” message, in a predefined format specified by the web service, to an appropriate endpoint. Upon processing information included in the message, the service may transmit a “response” message to the external application, which also has a predefined format specified by the web service.

A web service “contract” defines various characteristics of a web service, including functions or operations it provides, the format of request and response messages, the communication protocols it employs, and other features, behaviors and rules. As such, the web service contract provides a vehicle for describing a web service to external application. Web service contracts may be developed, for example, in the web service description language (WSDL), the SOAP Service Description Language (SSDL), or any other suitable description language.

A WSDL contract for a web service may define the format of a particular message in the form of an XML Schema. The XML Schema may be incorporated within the WSDL document itself, or may be defined by a separate XML Schema Document (XSD) and be referenced thereby. A WSDL document may also define a binding, or communication protocol, used by an endpoint to receive and transmit messages. For example, a contract may specify that an endpoint employs the Simple Object Access Protocol (SOAP), Hypertext Transfer Protocol (HTTP), Simple Mail Transfer Protocol (SMTP), or any other protocol.

Web services are generally developed according to one of two basic approaches. In private environments where information on functions provided by a web service may be more readily available, a “code-driven” approach is more common. According to this approach, the web service application code is developed first. The WSDL contract describing the web service may be developed later, or may be created automatically, for example, by the application, based on the application code. When a web service is deployed publicly, so that interoperability with external applications is of primary importance, a “contract-driven” approach is more common. According to this approach, the contract is typically developed first, and then an application which conforms to the contract is developed later.

### SUMMARY OF INVENTION

According to one embodiment of the invention, a computer-implemented method is provided for facilitating the definition of a contract for a web service, the contract defining an operation performed by the web service and a format of a message used to communicate with the web service to invoke the operation, the method comprising: (A) implementing at least one rule related to features of the web service, the at least one rule limiting the features of the web service to a subset of features, the subset of features comprising a portion of the features which could characterize the web service; and (B) presenting an interface to a user which enables the user to define the contract for the web service, the contract reflecting the features of the web service, wherein the interface enables the user to select features for inclusion in the contract from among the subset of features.

According to another embodiment, a computer-readable medium is provided having instructions encoded thereon, which instructions, when executed by a computer, perform a method of facilitating a definition of a contract for a web service, the contract defining an operation performed by the web service and a format of a message used to communicate with the web service to invoke the operation, the method comprising: (A) implementing at least one rule related to features of the web service, the at least one rule limiting the features of the web service to a subset of features, the subset of features comprising a portion of the features which could characterize the web service; and (B) presenting an interface to a user which enables the user to define the contract for the web service, the contract reflecting the features of the web service, wherein the interface enables the user to select features for inclusion in the contract from among the subset of features.

### BRIEF DESCRIPTION OF DRAWINGS

The accompanying drawings are not intended to be drawn to scale. In the drawings, each identical or nearly identical component illustrated in the figures is represented by a like numeral. For purposes of clarity, not every component may be labeled in every drawing. In the drawings:

FIG. 1 is a flowchart depicting an exemplary technique for facilitating the definition of a contract for a web service, according to one embodiment of the invention;

FIGS. 2A-2C depict exemplary graphical user interfaces for displaying information related to defining a contract for a web service, according to one embodiment of the invention;

FIG. 3 depicts an exemplary graphical user interface for displaying a WSDL document embodying a contract for a web service, according to one embodiment of the invention;

FIG. 4 is a block diagram of a computer system on which embodiments of the invention may be implemented; and

FIG. 5 is a block diagram of a storage system on which embodiments of the invention may be implemented.

### DETAILED DESCRIPTION

Applicants have appreciated that web services are deployed publicly with increasing frequency, such that interoperability between web services and external applications is becoming increasingly important. As a result, a contract-driven approach to developing web services is becoming increasingly common.

Applicants have also appreciated that conventional tools for developing web service contracts have several key deficiencies. Specifically, while conventional tools may enable a user to develop a sophisticated web contract by providing graphical or forms-based access to the varied functionality provided by web service description languages such as WSDL and SSDL, including parameters for protocols, message format and program calls, most of this functionality is typically not required by a user. Moreover, because conventional tools force the user to select from forms or graphical elements to employ specific functional concepts in a web service contract, the user must understand all of the varied functional concepts to create a valid contract using these tools. Further, because a number of conventional tools display concepts embodied in a web service contract as graphical elements that are connected via links, a crowded and visually confusing interface is frequently presented to the user. Because web service description languages such as WSDL and SSDL may be difficult for users to read and understand, using a basic editing application may not be a viable alternative to conventional tools for many users. Thus, deficiencies with conventional tools form a barrier to more widespread development of web services using a contract-driven approach.

According to one embodiment of the invention, a software application is provided which may address these and other deficiencies by making a number of simplifying assumptions regarding functionality which may be provided by a web service. These assumptions may be based on typical web service implementations, and may reduce the functional options available to a user for inclusion within the corresponding web service contract. For example, according to one embodiment of the invention, the software application may assume that a web service includes one or more endpoints, that each endpoint will employ a SOAP binding, and that specifications defined by the Web Services Interoperability Basic Profile Specification developed by the Web Services Interoperability (WS-I) Organization are followed. As an example, the WS-I 1.0 specification provides that a particular port type may not be used by more than one SOAP binding, that each message includes only a single part, and that SOAP messages follow a literal style.

Because fewer functional concepts are exposed to the user, a more intuitive approach to developing a web service contract may be facilitated.

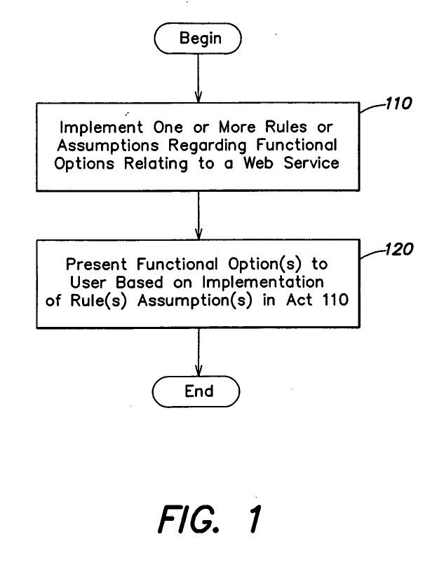

One embodiment of a process employed by the application to simplify and reduce the functional options presented to a user is shown in FIG. 1. Upon the start of process 100, act 110 is initiated, wherein the application may implement one or more rules or assumptions regarding functional options relating to a web service and therefore its contract, from among the functional options that may be specified for a contract via a web service description language such as WSDL or SSDL. For example, the application may implement a rule specifying that a contract may define endpoints as employing a SOAP binding only, from among all of the binding types which may be specified, and/or one or more other rules as desired. In act 120, the application may present one or more functional options to a user, based on the implementation of the rule(s) or assumption(s) in act 110. The process then completes.

According to one embodiment, the software application provides a graphical user interface (GUI) which enables a user to define a web service contract. The application may enable the user to define messages employed by the endpoint(s) provided by the web service, in an integrated fashion. That is, the GUI may allow the user to view and edit the format of messages and/or other characteristics of a particular function, operation or sequence of operations within the larger context of an endpoint, so that other messages and/or characteristics may be viewed easily and the relationship between those other messages and/or characteristics and the considered message may be easily discerned. Further, in one embodiment, the user may specify the format of one or more messages using a “design by example” approach, wherein the user may provide one or more example messages that conform to a prescribed format, and from which the format of the message may be inferred.

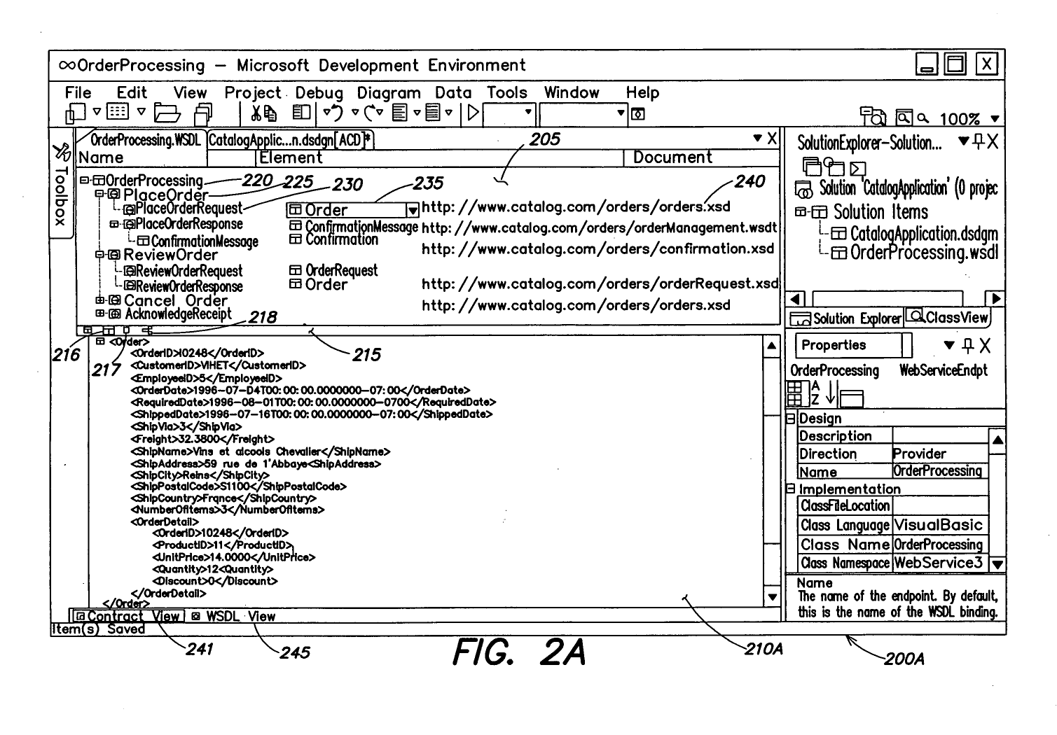

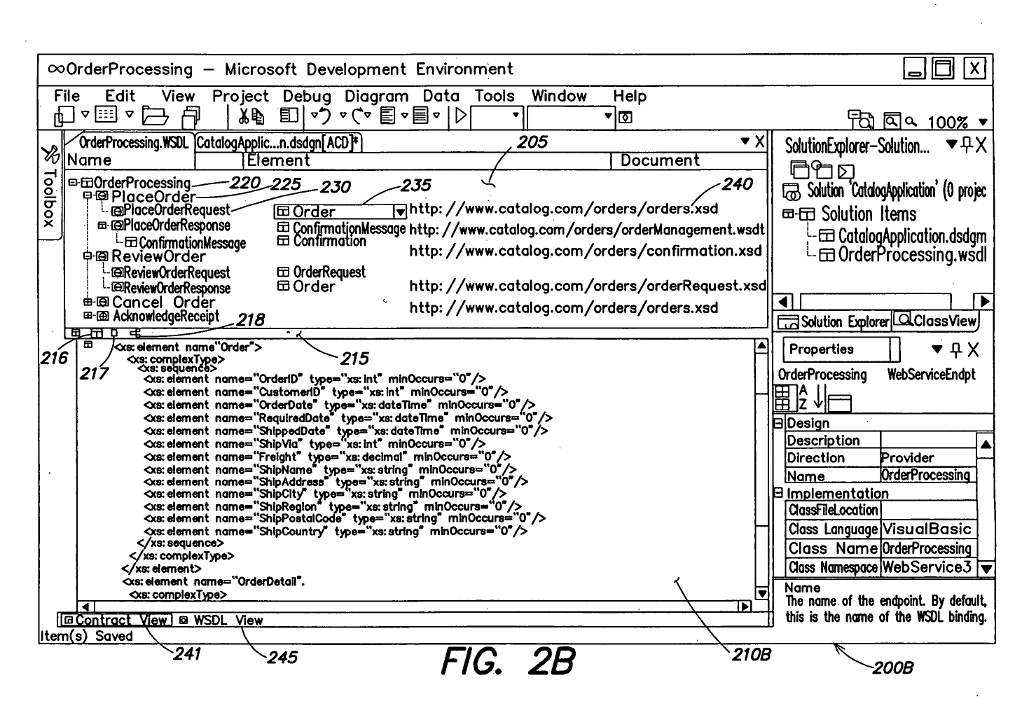

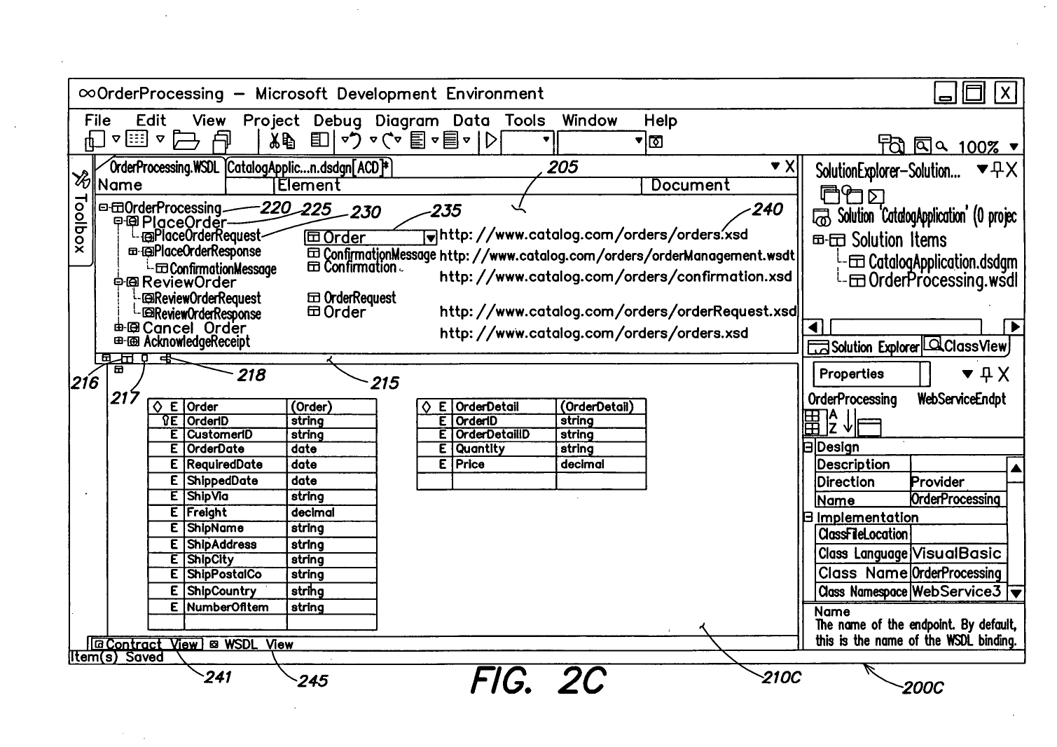

An exemplary interface which may enable the user to design a web service contract and the messages defined thereby is shown in FIGS. 2A-2C. It should be appreciated that although FIGS. 2A-2C depict a web service contract which is developed in WSDL format, any suitable format may be employed, including SSDL or any other suitable web service description language.

In FIG. 2A, interface 200A includes contract region 205 and message region 210, which are separated horizontally by application bar 215. In this exemplary interface, contract region 205 includes a nested display of functions or operations provided by the endpoint 220 (“OrderProcessing”), as will be understood by those skilled in the art, although any suitable display style may be implemented. Contract region 205 provides information related to each function or operation provided by an endpoint, including one or more messages associated with particular operations. For example, displayed in association with operation 225 (“PlaceOrder”), and more specifically with operation 230 (“PlaceOrderRequest”) is message element 235 (“Order”). Location 240 provides the web address of the XML schema (XSD) document which defines the format of order message 235.

In one embodiment, contract region 205 may enable a user to edit the functions or operations provided by an endpoint (e.g., endpoint 220) or various characteristics thereof. For example, a user may add to, remove or change operations provided by the endpoint, and designate particular operations to support requests (i.e., messages transmitted to the endpoint), responses (i.e., messages transmitted from the endpoint in response to a request), and/or other messages. User editing of operations may be facilitated in any suitable manner, as the invention is not limited in this respect. For example, contract region 205 may enable a user to add a function or operation to endpoint 220 by selecting an “Add” option from selection provided in an edit menu (not shown). In one embodiment, when a user adds to, changes or removes a function or characteristic thereof, commensurate modifications are made to the web service contract which the interface represents.

As can be seen by the highlighted element in contract region 205 in FIG. 2A, order message 235 has been selected (e.g., by a user) for manipulation or provision of input. In the exemplary interface shown, contract region 205 and message region 210A are functionally integrated, such that a selection of order message element 235 in contract region 205 influences information which is displayed in message region 210A. Any suitable information may be displayed in message region 210A, such as information related to order message element 235 (as shown), or any other attribute or characteristic of the endpoint, function or messages.

In the exemplary interface shown, the information related to order message 235 which is shown in message region 210 is controlled in part by the buttons 216-218 which are provided on application bar 215. For example, by pressing button 216 (as shown in FIG. 2A), a user may cause a sample order message (e.g., including sample data for the order message) to be displayed in message region 210. By pressing button 217 (as shown in FIG. 2B), a user may cause an XML schema which defines the format of the order message to be shown in message region 210. By pressing button 218 (as shown in FIG. 2C), a user may cause a graphical depiction of the XML schema which defines the format of the order message to be shown in message region 210. In one embodiment, one of buttons 216-218 may be configured as a default selection for the display of information in message region 210A. For example, the user's selection of order message 235 in contract region 205 may automatically cause a sample message to be displayed, as shown in region 210A in FIG. 2A. Any suitable information may be displayed, in any suitable manner, as the invention is not limited in this respect.

In one embodiment, each of regions 210A-210C may receive input from a user (e.g., via a mouse and/or keyboard), and may be functionally coupled so that each region informs or constrains the other regions. For example, a user may edit an XML schema for order message 235 in message region 210B (as shown in FIG. 2B), then press button 216 to switch to a display of a sample message (as shown in FIG. 2A), where sample data that conforms to the schema may be shown. The sample data that populates the sample message shown may be provided in any suitable manner. For example, data may be stored in a repository and accessed by the application during its operation, or exemplary data may be derived from the format of the message and presented in simplified or generic form. For example, an element in the schema which is defined as an alphanumeric string having five characters may be displayed as “xxxxx”.

Alternatively, a user may first edit a sample message in message region 210A, then switch to message region 210B (e.g., by pressing button 217), and an XML schema may be automatically inferred from the sample document. The application may, for example, apply one or more rules which define how a schema may be inferred from a sample. The rule(s) may be defined and/or implemented in any suitable manner. For example, XML schema inference rules defined by the XML Editor product offered by Microsoft Corporation of Redmond, Washington, may be implemented.

Of course, the software application need not be configured to automatically and/or unconditionally infer a schema from a sample message. For example, if the user supplies input to message region 210B which causes the sample message to no longer comply with its XML schema, the software application may prompt the user to confirm that changes to the schema are to be implemented, or request that the user cancel the changes to the sample data so that the data conforms to the prior schema, or to take any other suitable action. The application may also be configured to prompt the user to decouple the message regions 210A-210C, such that the user may proceed by editing the sample and/or schema in its respective region independently of the other “view”. Any suitable manner of message editing may be facilitated, as the invention is not limited in this respect.

It should be appreciated that providing the user with an ability to switch between displays of an XML schema and sample message, where the displays inform and restrain each other, may allow the user to design a message iteratively. In this respect, those skilled in the art will recognize that it is often difficult to conceive of an XML schema without first examining sample data, and that the nature of the XML language is such that it is nearly impossible to infer all aspects of a schema from sample data since specific restrictions can not be expressed in a message sample. Thus, some users may find the ability to design a message iteratively, by switching back and forth between sample data and a schema, to be valuable.

In one embodiment, the software application may be configured to allow a user to define any suitable number of samples for a particular message. For example, the application may provide the user with the capability to copy data from one sample message and paste the data into another sample message. A new sample may be added to a collection of samples for the considered message. Any suitable portion of sample messages in the collection may be functionally coupled to the schema, so that modifications to one sample may be used to update the schema and thus constrain the other samples.

It should be appreciated that although the contract region 205 and message region 210 are illustrated in FIGS. 2A-2C in a horizontal orientation, the invention is not limited in this respect. Regions of the interface 200 may be oriented in any suitable fashion. For example, regions may be shown as tabs on the display (as will be understood by those skilled in the art) so that only one region is shown to the user at a time, or as a separate application window, or in any other suitable fashion.

Further, it should be appreciated that a region of the interface (e.g., the region of the interface which is occupied by contract region 205 in FIGS. 2A-2C) may provide any other suitable information related to functionality defined by a web service contract. For example, some web service contracts may express more complex information exchange patterns than the operations depicted in contract region 205. These exchange patterns may be based on a sequence of exchanges, one or more rules which are expressed in terms of messages already sent or received (e.g. if message 1 and message 2 have been received by the web service, then message 3 may also be received), external events, or other suitable criteria. Information related to exchange patterns may be, for example, presented by an interface region which is analogous in appearance to either of regions 205 or 210 in FIGS. 2A-2C. For example, a region providing information on exchange patterns may be accessible via a tab metaphor and reside “behind” contract region 205. A region providing information on exchange patterns may, like regions 205-210, be functionally linked with one or more other interface regions. For example, an interface region providing information on exchange patterns may be functionally linked to message region 210, such that messages employed within an exchange pattern or sequence may be defined or exemplified.

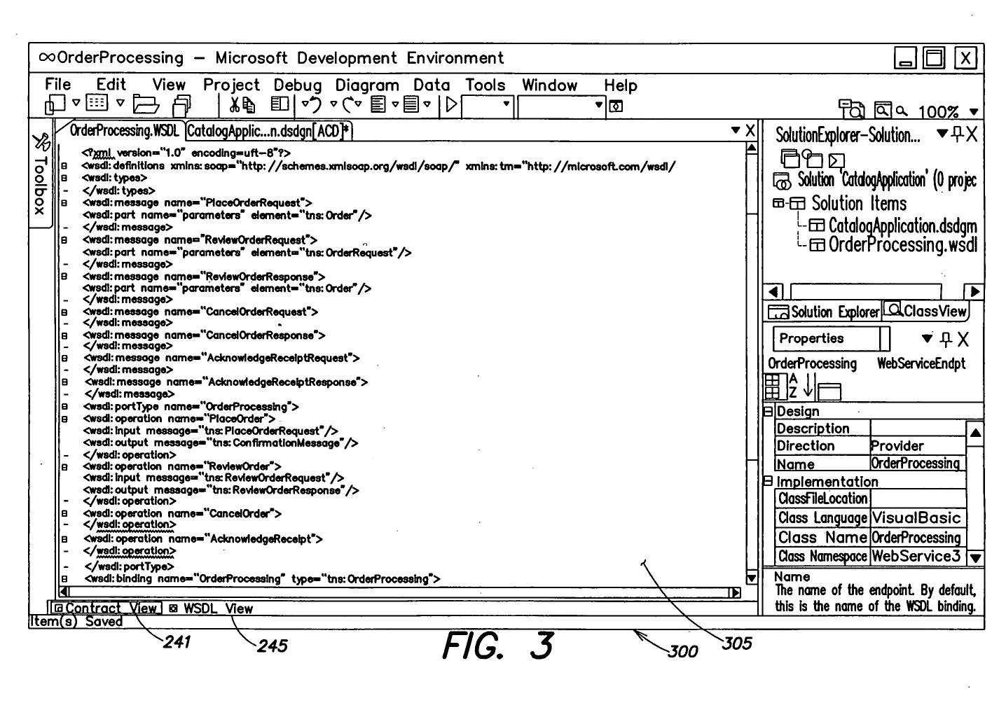

In one embodiment, the application may allow the user to view and/or edit the underlying web service contract which is produced via the features of the software application described above. FIG. 3 shows interface 300, wherein an exemplary WSDL document which defines the “OrderProcessing” endpoint is displayed for editing in region 305. As with FIGS. 2A-2C described above, although FIG. 3 depicts an interface for viewing and/or editing a WSDL document, an interface according to the invention may be adapted or configured to view and/or edit a web service contract provided in any web service description language, such as WSDL, SSDL and/or any other suitable language or format. The invention is not limited in this respect.

In the exemplary interface 300, this “WSDL View” may be generated when a user clicks on button 245 (also shown in FIGS. 2A-2C). This feature may, for example, allow the user to switch to a view the WSDL document after changes are made via the above-described features of the application, and then switch back to make additional changes.

While the WSDL view is displayed (as shown in FIG. 3), a user may make a change to the WSDL document which causes it to be incompatible with the functionality provided by the software application, since the software application specifically restricts the functional options available to the user. This situation may arise, for example, because the user wishes to define a majority of the document using the software application, but also wishes to make adjustments to aspects of the document directly. For example, a user may make changes to aspects of the WSDL document which can not be adequately represented by the tool. If incompatibility between the document and the software application occurs, the application may take any suitable action. For example, the application may inform the user of this condition and request that the user select from one or more remedies. For example, the application may request that the user either allow the application to make the document and application compatible by modifying the document, or decline to open the document with the tool.

It should be appreciated that the exemplary features described in the foregoing with reference to FIGS. 2A-2C and 3 are merely illustrative, and that many other features are envisioned. In one example, an interface may give a user the ability to implement one or more rules about a web service in general and operations or messages in particular, such as to implement statements of policy which must be followed by web services that implement the considered contract. In another example, a user may be given the ability to generate implementation code artifacts, such as exemplary classes and interfaces, which express or enforce aspects of a contract.

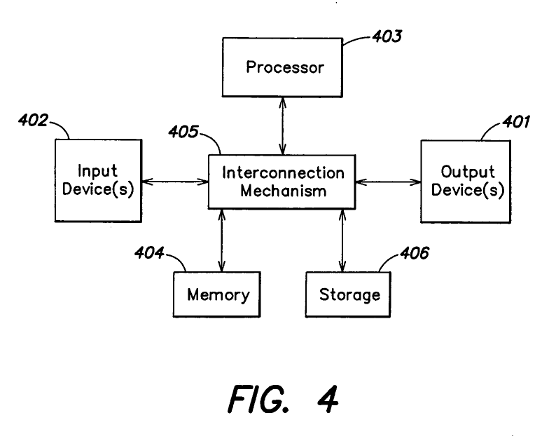

Various aspects of the invention may be implemented on one or more computer systems, such as the exemplary computer system 400 shown in FIG. 4. Computer system 400 includes input devices 402, output devices 401, processor 403, memory system 404 and storage 406, all of which are coupled, directly or indirectly, via interconnection mechanism 405, which may comprise a bus or switch. The input devices 402 receive input from a user or machine (e.g., a human operator, or telephone receiver), and the output devices 401 display or transmit information to a user or machine (e.g., a liquid crystal display).

The processor 403 executes a program called an operating system which controls the execution of other computer programs, and provides scheduling, input/output and other device control, accounting, compilation, storage assignment, data management, memory management, communication and data flow control. The processor and operating system define the computer platform for which application programs in other computer programming languages are written.

The processor 403 may also execute one or more programs to implement various functions, such as those which embody aspects of the invention. These programs may be written in a computer programming language such as a procedural programming language, object-oriented programming language, macro language, or combination thereof.

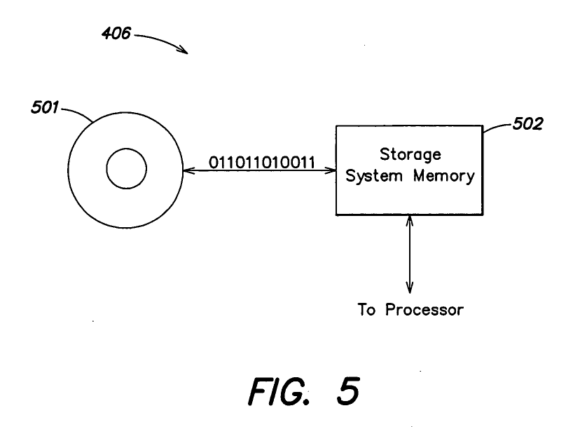

These programs may be stored in storage system 406. The storage system may hold information on a volatile or nonvolatile medium, and may be fixed or removable. The storage system is shown in greater detail in FIG. 5. It typically includes a computer-readable and writeable nonvolatile recording medium 501, on which signals are stored that define the program, or information to be used by the program. The medium may, for example, be a disk or flash memory. Typically, in operation, the processor 403 causes data to be read from the nonvolatile recording medium 501 into a volatile memory 502 (e.g., a random access memory, or RAM) that allows for faster access to the information by the processor 403 than does the medium 501. This memory 502 may be located in storage system 506, as shown in FIG. 5, or in memory system 404, as shown in FIG. 4. The processor 403 generally manipulates the data within the integrated circuit memory 404, 502 and then copies the data to the medium 501 after processing is completed. A variety of mechanisms are known for managing data movement between the medium 501 and the integrated circuit memory element 404, 502, and the invention is not limited thereto. The invention is also not limited to a particular memory system 404 or storage system 406.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer-implemented method of facilitating a definition of a contract for a web service, the contract defining an operation performed by the web service and a format of a message used for communication with the web service, the method comprising:
(A) implementing at least one rule related to features of the web service, the at least one rule limiting the features of the web service to a subset of features, the subset of features comprising a portion of the features which could characterize the web service; and
(B) presenting an interface to a user which enables the user to define the contract for the web service, the contract reflecting the features of the web service, wherein the interface enables the user to select features to be reflected in the contract from among the subset of features.

2. The method of claim 1, wherein the operation is exposed to an external application via an endpoint, and wherein the act (B) further comprises presenting an interface which includes a first interface portion which enables the user to modify a characteristic of the endpoint.

3. The method of claim 2, wherein the act (B) further comprises presenting an interface which includes a plurality of interface portions, the plurality of interface portions including the first interface portion and a second interface portion which enables the user to view and modify information related to a message employed by the operation, and wherein the first and second interface portions collectively enable the user to view the message in relation to the endpoint.

4. The method of claim 3, wherein the information related to the message includes one of an XML schema document (XSD) defining a format of the message, a sample of the message, and a graphical depiction of the XSD for the message.

5. The method of claim 4, wherein the act (B) further comprises presenting an interface which includes at least one tool, and wherein the at least one tool may be invoked by the user to change the information related to the message which is displayed by the second interface portion.

6. The method of claim 5, wherein the act (B) further comprises presenting an interface wherein information displayed by the second interface portion may be changed from first information to second information, and wherein the displays of the first and second information in the second interface portion are functionally coupled so that a change made by the user to the first information is reflected in the second information upon the occurrence of a change.

7. The method of claim 1, wherein the contract is provided in one of a plurality of formats, the plurality of formats including a Web Service Definition Language (WSDL) format and a SOAP Service Description Language (SSDL) format.

8. The method of claim 1, wherein act (B) further comprises presenting an interface which enables the user to view the contract in the one of the plurality of formats.

9. The method of claim 8, wherein the act (B) further comprises presenting an interface which enables the user to switch between a first interface view in which the contract is displayed in the one of the plurality of formats, and a second interface view in which a graphical representation of the contract is displayed.

10. The method of claim 9, wherein the act (B) further comprises presenting an interface which, upon an initiation by the user of a switch between the first interface view and the second interface view, performs a check to ensure that information presented in the first interface view is suitable for representation in the second interface view.

11. A computer-readable medium having instructions encoded thereon, which instructions, when executed by a computer, perform a method of facilitating a definition of a contract for a web service, the contract defining an operation performed by the web service and a format of a message used for communication with the web service, the method comprising:
(A) implementing at least one rule related to features of the web service, the at least one rule limiting the features of the web service to a subset of features, the subset of features comprising a portion of the features which could characterize the web service; and
(B) presenting an interface to a user which enables the user to define the contract for the web service, the contract reflecting the features of the web service, wherein the interface enables the user to select features to be reflected in the contract from among the subset of features.

12. The computer-readable medium of claim 11, wherein the operation is exposed to an external application via an endpoint, and wherein the act (B) further comprises presenting an interface which includes a first interface portion which enables the user to modify a characteristic of the endpoint.

13. The computer-readable medium of claim 12, wherein the act (B) further comprises presenting an interface which includes a plurality of interface portions, the plurality of interface portions including the first interface portion and a second interface portion which enables the user to view and modify information related to a message employed by the operation, and wherein the first and second interface portions collectively enable the user to view the message in relation to the endpoint.

14. The computer-readable medium of claim 13, wherein the information related to the message includes one of an XML schema document (XSD) defining a format of the message, a sample of the message, and a graphical depiction of the XSD for the message.

15. The computer-readable medium of claim 14, wherein the act (B) further comprises presenting an interface which includes at least one tool, and wherein the at least one tool may be invoked by the user to change the information related to the message which is displayed by the second interface portion.

16. The computer-readable medium of claim 15, wherein the act (B) further comprises presenting an interface wherein information displayed by the second interface portion may be changed from first information to second information, and wherein the displays of the first and second information in the second interface portion are functionally coupled so that a change made by the user to the first information is reflected in the second information upon the occurrence of a change.

17. The computer-readable medium of claim 11, wherein the contract is provided in one of a plurality of formats, the plurality of formats including a Web Service Definition Language (WSDL) format and a SOAP Service Description Language (SSDL) format.

18. The computer-readable medium of claim 11, wherein act (B) further comprises presenting an interface which enables the user to view the contract in the one of the plurality of formats.

19. The computer-readable medium of claim 18, wherein the act (B) further comprises presenting an interface which enables the user to switch between a first interface view in which the contract is displayed in the one of the plurality of formats, and a second interface view in which a graphical representation of the contract is displayed.

20. The computer-readable medium of claim 19, wherein the act (B) further comprises presenting an interface which, upon an initiation by the user of a switch between the first interface view and the second interface view, performs a check to ensure that information presented in the first interface view is suitable for representation in the second interface view.
